(19) United States
(12) Patent Application Publication
(10) Pub. No.: US 2010/0054568 A1
(43) Pub. Date: Mar. 4, 2010

(54) METHOD AND APPARATUS FOR SELECTING A VOLUME OF INTEREST IN ONE OR MORE IMAGE DATA SETS

(76) Inventors: Scott Baker, Edwardsburg, MI (US); Andrea Endreß, Wilmmelbach (DE); Sigrid Ferschel, Uttenreuth (DE); Manfred Koch, Röttenbach (DE); Stefan Lautenschlager, Hausen (DE); Martin Trini, Förth (DE); Stefan Weyers, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/547,816

(22) Filed: Aug. 26, 2009

Related U.S. Application Data
(60) Provisional application No. 61/092,853, filed on Aug. 29, 2008.

(51) Int. Cl. G06K 9/34; G06K 9/00

(52) U.S. Cl. 382/131; 382/173

(57) ABSTRACT

The invention relates to a method for selecting a volume of interest in one or more digitized images. A geometric structure in the digitized image for selecting a volume of interest is defined. A segmentation of the volume of interest in the digitized image is performed and visualized. The invention further relates to an apparatus, in particular a computer for performing the methods and a computer storage device comprising machine readable and executable program instructions which comprise steps of performing the methods. The invention can be applied for modern imaging developments, such as Computed Tomography, Angiography, and Magnetic Resonance Imaging which have made possible the acquisition of volumes where a volume of interest, e.g. the whole blood vessel tree, can be accurately visualized.

### CROSS REFERENCE TO RELATED APPLICATIONS

The present application claims the benefit of a provisional patent application filed on Aug. 29, 2008, and assigned application No. 61/092,853, which is incorporated by reference herein in its entirety.

### FIELD OF THE INVENTION

The present invention relates to a method and an apparatus for selecting a volume of interest, e.g. a vascular structure of a body volume of a patient, in one or more digitized images or image data sets (preferably 3D data).

### BACKGROUND OF THE INVENTION

Blood vessel segmentation is important for clinical tasks such as diagnosis of vascular diseases, surgery planning and blood flow simulation.

Modern imaging developments, such as Computed Tomography (CT), Angiography (e.g. DynaCT, 3D-Angiography) and Magnetic Resonance Imaging (MRI) have made possible the acquisition of volumes (3-D) where the whole blood vessel tree can be accurately visualized. Such volumetric techniques have become an attractive extension to conventional 2D-angiography.

In order to detect the vessel shape of a vessel tree in a 3-D reconstructed volume a segmentation algorithm is performed on the underlying reconstructed data.

After this initial step the region of interest for treatment/diagnosis can be defined. Said initial step enables measurements on this region and analysis thereof (e.g. stenosis or aneurysm). Usually the reconstructed 3D-volumes consist of a lot of data due to large matrix sizes and high bit-depth.

However, due to the constantly increasing volume of generated data, the amount of computation needed to extract relevant information quickly becomes prohibitive.

According to US 2007/0031019A1 there is a method for segmenting coronary vessels in digitized cardiac images including the steps of providing a digitized cardiac image comprising a plurality of intensities corresponding to a domain of points on an N-dimensional grid, providing a seed point in said digitized image, selecting a volume-of-interest about said seed point, performing a local segmentation in said volume-of-interest, including initializing a connected component with said seed point and a threshold intensity value to the intensity of the seed point.

After providing said seed point vessel segments (volume of interest) are iteratively extracted by an automatic deterministic threshold selection with a connected-filter-like approach, followed by post-processing steps.

This iterative approach is too complicated and time-consuming for physicians who firstly need a fast and quite rough selection of the volume of interest prior to analysis in more detail.

### SUMMARY OF INVENTION

It is an objective of this invention to improve support for the afore mentioned segmentation process.

Said problem is solved by the features mentioned in the independent claims. Preferred embodiments of the invention are described in the dependent claims.

An aspect of the invention is a method for selecting a volume of interest in one or more digitized images comprising the steps of:

a) defining at least one geometric structure in said digitized image for selecting a volume of interest,
b) performing segmentation of said volume of interest in said digitized image and
c) visualizing said segmented volume of interest.

According to an embodiment of the invention said geometric structure can be represented by a circle, rectangle, sphere and/or cube.

According to a further aspect of the presented invention a point of interest is provided in said digitized image and said geometric structure is defined about said point of interest for selecting a volume of interest.

Said definition can be performed via a user interface and/or said point of interest can be provided via a user interface.

Preferably said point of interest is located in the center of said volume of interest. Said geometric structure can be particularly represented by a circle, rectangle, sphere and/or cube.

In contrast to the afore mentioned prior art, wherein said volume of interest is defined by an automatic interactive segmentation process which is started directly after setting a seed point, according to the presented invention said volume of interest is firstly automatically and/or manually defined before starting a segmentation process. In other words, the presented invention is based on a non-iterative approach.

Further aspects of the invention are an apparatus, in particular a computer system configured in any manner for performing the afore mentioned inventive methods and a computer storage device comprising machine readable and executable program instructions which comprise steps of performing the afore mentioned inventive methods.

The proposed invention provides the following advantages:

Providing an additional work step of selecting the volume of interest and its size before segmentation. This additional step accelerates the 3D-volume analysis process in particular vessel tree analysis, which yields more efficiency for treatment and for workflow prior to or during intervention.

The physician easily obtains all image data information needed for treatment and invention.

### BRIEF DESCRIPTION OF THE DRAWINGS

Preferred embodiments of the present invention will now be described with reference to the accompanying drawings in which:

FIG. 1 schematically shows a vessel structure and the inventive selection of the volume of interest and

FIG. 2 schematically shows an apparatus according to the invention which comprises a system for performing the necessary steps of the described inventive method.

### DETAILED DESCRIPTION OF THE DRAWINGS

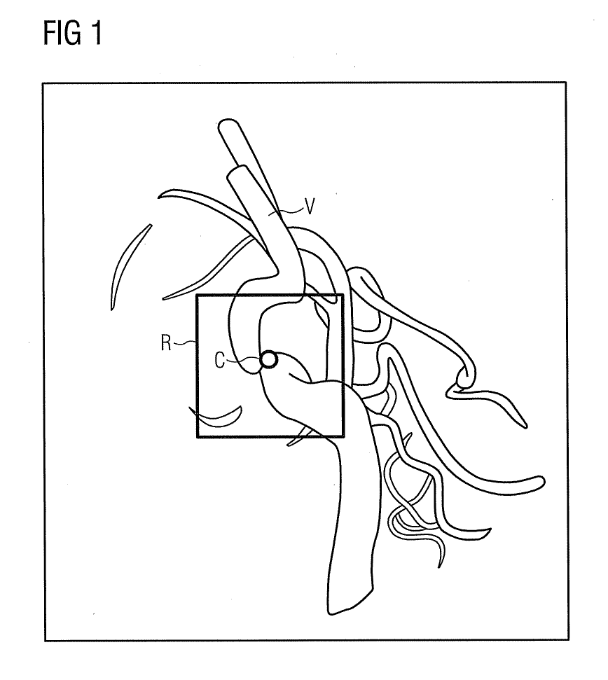

A selection method according to an embodiment of the invention is depicted in FIG. 1. In FIG. 1 a vessel tree V is illustrated. Exemplary embodiments of the invention as described herein generally include systems and methods for selecting a “Volume of Interest (VOI)” in particular prior to segmentation. By defining a “Point of Interest (POI)”, preferably a “Center of Interest (COI)”, e.g. red ring C, and the “Size of Volume of Interest (VOI)”, e.g. red cube R, the initial image analysis can be accelerated according to the selected size of VOI. The shape used for the definition of the “Volume of Interest” may be defined as another geometric structure (e.g. circle (2D)/Sphere (3D)).

Said definition, in particular providing a point of interest, can be performed by a physician via a user interface (e.g. keyboard, computer mouse, touch screen, joystick etc.).

A further solution for defining the volume of interest is to place a geometric structure without defining the “Center of Interest” point before. In this case the step “providing a Point of Interest” of the above mentioned inventive method is not necessarily required.

As used herein, the term “image” refers to multidimensional data composed of discrete image elements (e.g., pixels for 2-D images and voxels for 3-D images). The image may be, for example, a medical image of a subject collected by computer tomography, angiography (DynaCT, 3D-angiography), magnetic resonance imaging, ultrasound, or any other medical imaging system known to one of skill in the art. The image may also be provided from non-medical contexts, such as, for example, remote sensing systems, electron microscopy, etc.

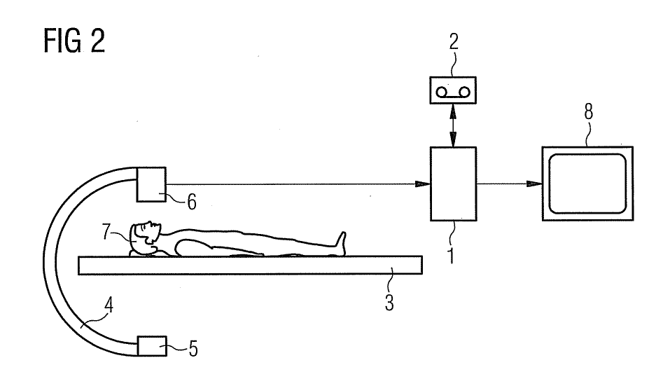

Although an image can be thought of as a function from R³ to R or R⁴ to R—if time-dependent 4D-data (e.g. cardiology) is used—, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image. An example for such an acquisition system is illustrated in FIG. 2.

With reference to FIG. 2 an apparatus, preferably a X-Ray apparatus, is shown. A surgical instrument (not shown in the figure) can be navigated through a vascular structure of a body volume (volume of interest) of a patient 7. The system comprises a table 3 for supporting the patient and in the shown preferred embodiment it comprises a C-arm 4 with a X-ray source 5 and an image intensifier (or flat panel X-Ray detector) 6 for acquiring a series of images. The image intensifier is connected to a processing system 1, preferably a computer system, which can be directly or remotely connected to a storage device 2 and a display unit 8.

It is to be understood that the present invention can be implemented in various forms of hardware, software, firmware, special purpose processes, or a combination thereof. In one embodiment, the present invention can be implemented in software as an application program tangible embodied on a computer readable program storage device.

The application program can be uploaded to, and executed by, a machine comprising any suitable architecture.

Software modules for performing the inventive method can be implemented for example in said processing system 1 or in a workstation (not shown) connected to the processing system via a computer network. A storage device connected to the workstation and/or said storage device 2 can comprise an executable program of instructions to perform program steps for the afore described inventive methods.

1.-9. (canceled)

10. A method for selecting a volume of interest in an image of a patient, comprising:
defining a geometric structure in the image;
selecting the volume of interest based on the geometric structure;
segmenting the volume of interest in the image; and
displaying the segmented volume of interest.

11. The method as claimed in claim 10, wherein the geometric structure is defined via a user interface.

12. The method as claimed in claim 10, wherein the geometric structure is represented by a circle, a rectangle, a sphere, or a cube.

13. The method as claimed in claim 10, wherein a point of interest is provided in the image and the geometric structure is defined about the point of interest.

14. The method as claimed in claim 13, wherein the point of interest is provided via a user interface.

15. The method as claimed in claim 13, wherein the point of interest is located in a center of the volume of interest.

16. The method as claimed in claim 10, wherein the volume of interest comprises a vascular structure of a body volume of the patient.

17. The method as claimed in claim 10, wherein the image is a digitized image.

18. The method as claimed in claim 10, wherein the image is a three-dimensional image.

19. An apparatus for selecting a volume of interest in an image of a patient, comprising:
an image recording device that records the image of the patient;
a processing unit that:
defines a geometric structure in the image,
selects the volume of interest based on the geometric structure, and
segments the volume of interest in the image; and
a display unit that displays the segmented volume of interest.

20. A computer-readable storage medium encoded with a computer program to execute a method by a computer for selecting a volume of interest in an image of a patient, the method comprising:
defining a geometric structure in the image;
selecting the volume of interest based on the geometric structure;
segmenting the volume of interest in the image; and
displaying the segmented volume of interest.
